(19) United States
(12) Patent Application Publication
(10) Pub. No.: US 2002/0062276 A1
(43) Pub. Date: May 23, 2002

(54) Wireless distributed certified real time bidding and tracking system for live events

(76) Inventors: Craig Krueger, Fort Lee, NJ (US); Lawrence Glaser, Fairfax Station, VA (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 10/054,903

(22) Filed: Jan. 25, 2002

Related U.S. Application Data
(63) Continuation-in-part of application No. 09/912,557, filed on Jul. 26, 2001.
(60) Provisional application No. 60/222,727, filed on Aug. 3, 2000.

(51) Int. Cl. G06F 17/60

(52) U.S. Cl. 705/37

(57) ABSTRACT

A wireless distributed certified real time bidding and tracking system for live events, such as a live auction. An auctioneer selects an auction site to conduct the live auction, and the auction site can be a site that is remote from bidders. Attendees of the live auction include live bidders, wireless bidders, or a mix of each. A Local Auction Management Server (LAMS) is set up at the auction site, though can also be located remotely and accessed by a remote client, from the live auction site. The LAMS server communicates in real time with a Proxy Server in communication with the wireless network. A live bidder, who has a wireless device in his/her possession, can arrange to be notified of the commencement of the auction, the impending auction of items they are interested in and can submit bids before the auction, during the auction and in some cases, after the auction has ended. A time date stamp function is associated with all actions taken at the wireless device. This time date stamp can be derived by the device, or by the network receiving the command. In either case, the Wireless Network Proxy Server records and transmits the event to the LAMS server. The time date stamp allows bidders submitting bids through the wireless connection, to be treated fairly as to when bids are placed in order to determine who bid first and/or last. All elements of the system of the present invention are synchronized to a single clock source.

### RELATED APPLICATION

This application is a continuation-in-part of Ser. No. 09/912,557 filed Jul. 26, 2001, which claims priority to provisional application serial No. 60/222,727, filed Aug. 3, 2000.

### BACKGROUND OF THE INVENTION

There are many live events for which a wireless subscriber may wish to use their wireless device in order to participate in that event. One such event is a live auction. A “live” event, such as an auction, is one that is held at a single location such as an auction house, or an electronic auction house, and typically includes an auctioneer, bidders and items up for auction. Attendance at live auctions has become a harrowing experience, from a perspective of traveling, efficient use of time and effort and from a perspective of attempting to attend via the Internet or other means less reliable than live attendance.

The Internet does not provide a guarantee of receipt and processing of bids and does not receive and process bids in a real time fashion for live auctions. A device is therefore needed to facilitate remote real time auction participation with certification and notification of completed processing of bids. In addition, a wireless network is needed to serve wireless subscribers in real time and facilitate real time participation in a live auction.

Everyone is typically familiar with the concept of an auction. An auction is generally advertised to solicit qualified bidders. The merchandise is accurately described, preferably including enough information to obtain the best price for the seller and a fair price for the buyer. The greater the credibility of the auction house, the greater the participation in terms of quantity and quality of bidders.

In this age of electronics and networking, the Internet has emerged as one embodiment useful as a tool, to increase participation in an otherwise less efficient auction event. Although the Internet is indeed formidable and bandwidth concerns are perpetually improving, the Internet is not intended to be a non-blocking environment. Further, there are many layers of technology that form an interdependence. This interdependence causes bottlenecks and failures. Most importantly, the Internet is least reliable when a real time event needs to be broadcast. Indeed, the Internet may never be reliable for broadcasting an actual event in virtual real time. Additionally, bidders are not necessarily available when the actual item is to be sold, with Internet access at hand, for whatever reason that may exist at that moment.

Functions such as the transmission of voice, time critical data or video, continues to be a function left to the Public Switched Telephone Network, Cellular Networks, Satellite Networks, Cable Television Networks, Fiber Optic Networks, Private Networks and the like. In fact, there is a clear differentiation between the Internet, which is hosted on a virtual backbone, and the backbone carrier technology, which is further hosted by one or another carriers network. The Internet and the World Wide Web are wholly virtual, and thus dependent upon some form of backbone to carry the concept from portal to portal.

In contrast to the Internet, the PSTN is engineered to create a connection and hold the connection for definitive periods of time. The Internet makes no such distinction, particularly for content transmitted and received. When bidders attend an auction through any means, more particularly a live auction for choice goods or services, there is a criticality formed within the given environment. Bidders competing for high end goods, services, collectibles and antiques, want to know several things about the real time environment within which they are about to compete.

The concerns range from accessibility, fairness in receiving recognition of a bid, the ability to receive and to signal confirmation of a bid, the ability to retract a bid, the ability to halve the difference between current bid and next offer. Each of these opportunities afforded to all bidders on a fair basis, act as important elements of feedback which big ticket participants must have, to make their best bids. In an open room facility, most of this falls to the auctioneer and his/her assistants. They develop the expertise to determine who is bidding, including all the signals made by the bidding audience, to indicate each and every aforementioned concern or other concerns that accompany the nervousness and outright buying frenzy the seller and the auctioneer want to foster.

Indeed, the real time feedback element is the most critical element to deliver to the bidder, in order to foster fair competition and the highest reasonable price for the auction house and for the seller. A bidder does not want to feel left out or unacknowledged for their participation, even if they are not successful in obtaining the item of interest they have targeted. The bidder should be confirmed that they have placed a good bid and receive recognition of their bid.

In addition to all of these fundamental concerns, there are other broad concerns that also serve to limit participation. A bidder may elect to participate, solely because there are enough items of interest to make the necessary expenditure of time, travel and capital worthwhile. Practicality can also limit participation. The purchase of excess building materials can be delimited by territory, in that the cost to transport outside a given geographical range exceeds the value obtained in the transaction. All of these basic elements combine to form the general spectrum of concerns for a seller, auctioneer and a buyer, in the fair disposal of goods, services, collectibles, rarities and antiquities in modem society by way of the auction concept. Real time feedback is crucial.

Indeed, some wireless devices contain Internet browsers and to some extent, may be able to find an auction, provide enough information to the user and actually enter a bid for the user. However, as this means is wholly dependent upon the Internet, it is not real time and cannot be guaranteed as such. The bidder is not truly certain that the bid has been entered and further, there is no means of receiving feedback, directly from the auctioneer to the user, as the bid is entered. Consequently, present systems do not guarantee proper receipt and confirmation of the time, date and decision to bid aligned with the time and date the decision is actually made, as a single real time action.

Other live events could include gaming participation, securities trading, payment of bills, voting or any other live activity where a system such as herein described would be beneficial to the subscriber.

### SUMMARY OF THE INVENTION

Accordingly, it is an object of the invention to provide a real time tracking and bidding system for use with live auctions or any auction(s). The invention increases participation in real time auctions, and especially in live auctions.

Generally, the method and device of the present invention harnesses the best geographically unbounded real time systems available, with an auction event. The age of wireless communication is exploding. The present system combines the overall communications capabilities of the hand held wireless device with the real time events of a live auction. In addition to this critical linkage, comes the various issues of notification to the hand held wireless device user and the ease and efficiency of the users interface to select the auctions, the items and any early notification steps or real time notification steps the user wishes a wireless system to enact.

During the auction, the feedback the wireless user receives can be crucial to forming a desire for the technology and the certainty that the technology is working to benefit the attendee. Broadly speaking, wireless devices range from hand held personal cellular telephones, to palm top computers, wrist watches and intelligent alphanumeric pagers. Even the notebook or laptop computer becomes transformed, when wireless means are made available to such devices.

The wireless device is used to pass information to an auction participant and to receive information from an auction participant, through the supportive network of the wireless device, to the auction management system. According to current technology, this entails the use of a display, keyboard or buttons, a touch screen, a standard home or business telephone, or even spoken communications to and from a telephone or the wireless device. The challenge is to broadcast certain real time information to the device and receive feedback from the device in the form of real time, precise time date stamped actions taken by the user of the device and the provision of additional similar communication(s) to and from the device, to facilitate and emulate live bidder participation formerly experienced solely through live presence at the actual auction in question.

### BRIEF DESCRIPTION OF THE FIGURES

FIG. 1 shows the wireless distributed real time bidding and tracking system in accordance with the preferred embodiment of the invention.

FIG. 2 shows the wireless distributed real time bidding and tracking system in accordance with an alternative embodiment of the invention.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

The wireless device is used to pass information to an auction participant and to receive information from an auction participant, through the supportive network of the wireless device, to the auction management system. According to current technology, this entails the use of a display, keyboard or buttons, a touch screen, or even spoken communications to and from telephones or the wireless device. The challenge is to broadcast certain real time information to the device and receive feedback from the device in the form of real time, precise time date stamped actions taken by the user of the device and the provision of additional similar communication(s) to and from the device, to facilitate and emulate live bidder participation formerly experienced solely through live presence at the actual auction in question.

One key element of this invention is the time/date stamp of events. Another key element is the reliance upon a network, which is a real time network and thus, can carry real time events from bidder to auctioneer and from auctioneer to bidder. In fairness to all participants at an auction, more particularly those bidding on big ticket items, the act of bidding needs to be real time and verified, to make all bidders, sellers and auctioneers comfortable with the system.

Certification of these elements provides a level of comfort the bidders will require, in order to place their most generous bids. Certification is made verifiable through the use of synchronization of all real time events, to a reliable clock source for time and date verification. One preferred source is the U.S. Naval Observatory cesium clock. In essence, each event, such as a broadcast of information from the auction to the hand held wireless device, the receipt of the event message at the device, the event of a key depression at the wireless device and the receipt of the key depression at the auction, can each be time/date stamped verified and confirmed.

Encryption can be applied to the communications, to assure security. The wireless device could echo the message back to the auction, to verify receipt of the proper message, without corruption of the information. This creates a system with the ability to track and indeed certify, verifiable events. Such events can be timed to the tenth, one hundredth or even thousandth of a second. The events can be stored so all bidders can view the events from an archive. This builds trust and endears the bidders to the system. These are features extolled and touted during the sales of these specific services to potential auction participants.

In one preferred embodiment, these elements may include a hand held wireless device, satellite, switch and towers serving the device (network), a proxy server located on the network and a proxy server located at the auction site or remote to the auction site, with remote access from the auction site to the auction server with integration between all servers. The Internet can be used as a carrier to allow the auction server to communicate with the actual auction site.

However, the system can be implemented in any suitable manner with any suitable devices and network. The use of the Internet to allow the auction server and the proxy server to communicate may also be implemented in any suitable manner, such as for instance a private network serving the devices. But the low cost nature of the Internet may invite such use. In order to make certain the Internet and the proxy server are able to communicate in real time, dial up services or dedicated services between these elements may be required. These services could include packet switched networks or satellite networks. Any real time network with reliability will suffice.

The auction house lists the item and creates the marketing elements for a given auction. The end user subscribes or indicates an interest in attending this auction. This could be accomplished in a number of ways, including Internet GUI and Internet GUI overlaying data base capabilities, which include search, monitor, identify and desired action per search, monitor event or successful identification the data base and GUI mitigated preferences can acquire.

This is a more advanced and preferred means to find items, auctions, availabilities and other permutations for all data observed at an auction. A user could have a desire to track a certain seller, certain items, highly specific items, or a broad range of items, items of a certain specificity being sold during a certain date or time range. The permutations are seemingly endless, but this invention can assist in finding the information the auction participant is seeking, and linking them to the acquisition of the event with a means to participate that is believed to be superior. The user can always call the auction house or even through the hand held wireless device or even through mailings. The day the auction commences, certain reminders could be set in advance, to warn the user that the auction has commenced. Upon contacting the user, say by way of the display of the wireless receiver, the user could be required to acknowledge the message.

By failing to acknowledge, the auction server could locate the user and deliver a message through a variety of means, such as to dial the user and deliver a voice message or page the user. Notification for big ticket auctions is very important. As the wireless device is typically capable of more than voice, data and video communications, other means exist to contact the user. These would be fully exploited by the overall system formed from these innovative designs. When the item up for bid becomes a real time event, the user is expected to be viewing any display they have on their wireless device. The auction, item number, current bid, current offer, current bidder, and an expiration timer could be present on this display.

The users device could offer several one touch functions, such as bid, halve the bid, cancel bid, verify the bid, retraction of the bid with confirmation or a re-open of the bidding for an item. Upon successfully submitting the winning bid, the auction server could ask the device user for verification. This could include password protection, in case the user has lost the device and an unknown party is bidding, as a prank or in malice. The auction server could alert the auctioneer when items which have been won by the user, are not verified in a certain amount of time.

Hence, automatic re-opening of the bid could be automated. For example, if there were multiple bidders bidding $ 10,000 for an item and (obviously) one bidder was first, the offer to verify comes after bidding on the item has closed. If the user fails to verify their bid, the event is logged (so the auctioneer can decide if this bidder has violated terms or made an honest error). As a back-up, just in case the wireless bidder has a loss of signal event or a dead battery, just after winning a bid, there could be specific instructions to the bidder to follow.

In the event of default, the item could be offered conditionally to the next bidder (in time) who bids, even if offered at the same bid amount of $10,000. They could be fairly warned that the last bidder failed to respond to verification, so the item may still be rightfully theirs. The rules could say the successful bidder has 1 hour to respond to verification, which could include an automated voice processing system as a backup and plain old telephone service (to the auctioneers assistants) as a tertiary back-up, to verify the bid. Wireless devices are subject to occasional interference or loss of power. Bidders knowing the rules would know what has to be done to preserve the bid. After the expiration of this intentionally flexible timer, the item goes to the next bidder at the last known bid price. Best of all, this could be entirely automated, to remove the effort and opportunity to err, from the auctioneer.

Preferably, the system can be implemented with any suitable wireless device to provide presentation of time/date, synchronized to a known source, such as the naval observatory clock. However, it is critical to this application, to assure bidders their opportunities are not compromised or prejudiced by a less than perfect system. The bidder who bids highest at the official close wins the bid. Verification is present for errors made, allowing the system to accomplish all desirable functions possible and permit the auction to continue with efficiency.

Again, it cannot be overemphasized how bidders competing for big ticket items need these forms of assurance and feedback, that their bids are wanted and needed, that their participation is true and real time and that all of the events are fair and impartial. The ability to know the exact timing of each and every event, to store the activity of all events and to release this data to the participating parties is paramount to achieving the same conditions bidders are accustomed to by being present at a standard live auction environment. Any suitable means can be used to access these logs, replay of events, listing the items you have won, totaling user expenditures, setting limits, etc, are all known to those skilled in the art. One important aspect of the invention is the real time communication with time/date stamped verification of each measurable event according to a synchronized clock.

There are added dynamic advantages to this system that could cause the bidders to attend the auction in person and yet, use the wireless device to bid. For example, the depression of a key on the device is not noticeable by competitive bidders. The bidder may desire this as big ticket items are intimidating, by nature. Silent bidding is usually a practice facilitated by a written, prearranged bid. Bidders may want to remain anonymous. However, the device works in perfect anonymity. No one really knows who pressed what button! Additionally, the wireless device offers the ability to quickly retract a bid; an accidental bid for the wrong item number. It is less embarrassing to simply retract in case of an error, through use of a button. Abuse of this feature could eject the bidder (automatically if necessary).

Promotional advertising can also be facilitated by the system. If you attend the auction for all items, and bid on at least 10, one of the remaining bidders will randomly receive a gift certificate for 2% off the buyers premium at the next auction, etc. . . . Because the attendance is tracked electronically, such as logging in to the event, continuing presence and active bidding can be rewarded. No such capability exists today and certainly not for remote bidders to a regional event through the use of hand held wireless devices. A data mining opportunity is embedded, in the form of knowing who bids for what categories, how high as a percentile of the national average and how frequently. Also the total expenditures, which lead to the private compilation of better and better lists of qualified buyers.

Another issue, clearly intended by this innovative approach, involves the practicality of the entire concept. Using personal communications devices is important since people are getting used to a world and to a society that relies upon the personal wireless communications device for essentially all communications. With proper features, functions, verification means, certification and fairness elements, people will be satisfied and more likely to participate and bid. Sellers maximize return and the owners of the system generate goodwill, commissions and revenue.

The auction house can conduct the auction more smoothly, catering to a far greater attendance. Many issues that cause a halt or confusion in a large auction, are avoided. Bidders have access to a data base of events, knowing that fairness prevailed in the system. All of this is made possible, by modifying the functions of a wireless device, to meet the demands of an auction environment in the best possible manner as described herein.

As will be readily apparent, the present invention also has uses to interface a wireless environment with the Internet for real-time bids, as well as business-to-business applications. The system can also accept pre-auction bidding and keep track of user profiles such as items bid on, the number of bids, bid increment.

The system can also be used for neural buying and selling. A user can set preferences (such as maximum bid amount and items to bid on) and the system will keep track of on-going auctions and search for items to bid upon based on the user preferences. The system can then either prompt the user as to the presence of an auction of interest or automatically bid upon the located item. In addition, if a bidder is not available, the system can be directed to a backup bidder (agent bidder) to make any decisions. In order to facilitate application development, an open-ended platform is provided. Any suitable systems or devices can be used.

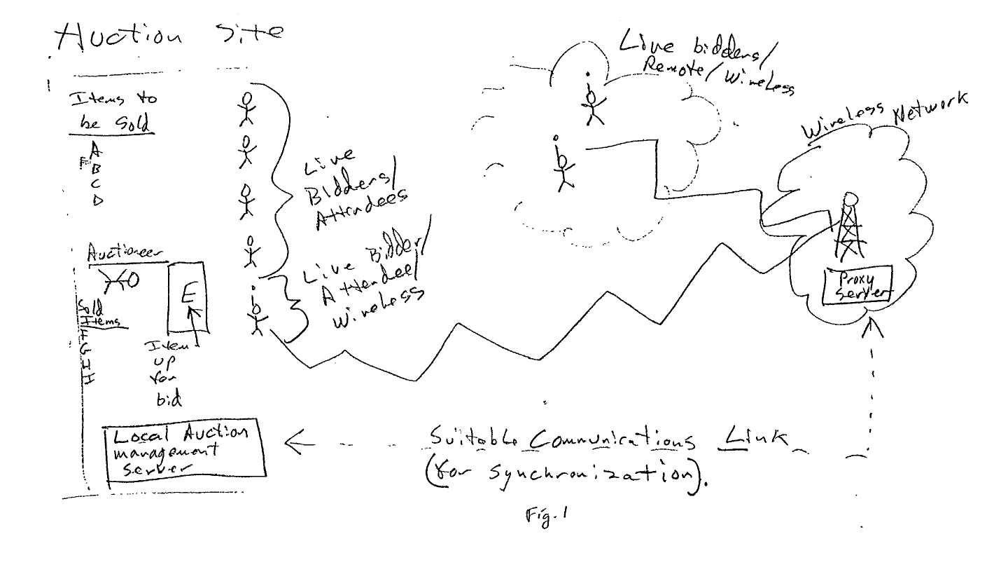

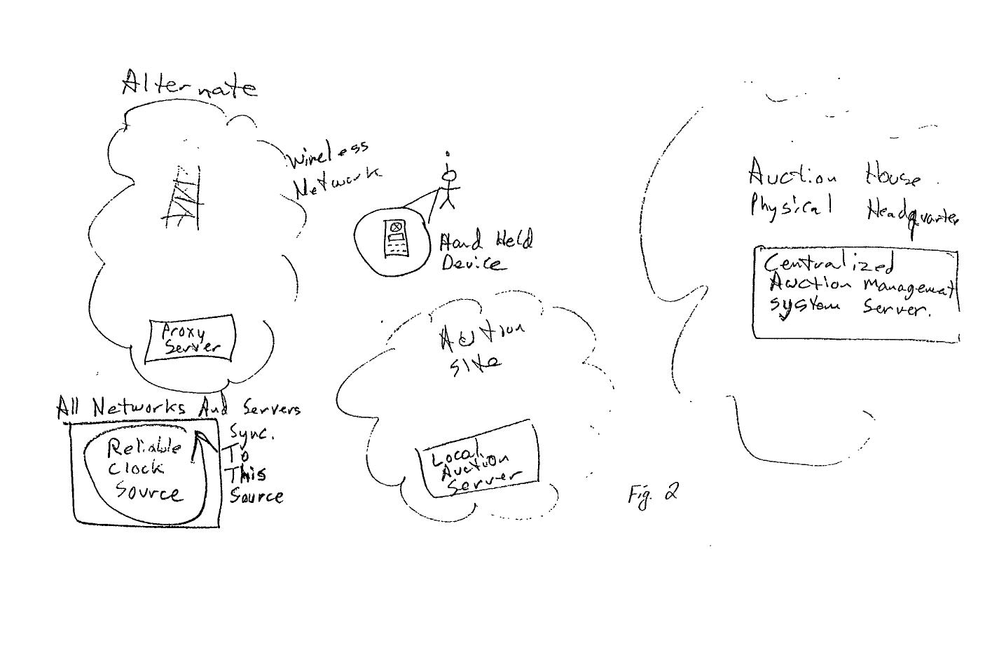

A preferred embodiment of the invention is shown in FIGS. 1 and 2. The premise of the system is to provide portability, or work as a stationary auction management system, where wireless devices are allowed to participate in a live auction, in real time. As such, many suitable design elements can be used without departing from the scope or meaning of the invention.

Live auctions require a few simple elements. Items to be sold, a seller, a buyer and an auctioneer. There are rules set forth, which govern the very concept. Probably the most endearing rule is to have a time and date the bidding commences and a time and date where bidding ends. More specifically, each item may be brought up for bid, allowing any mail in bids, left bids, E-Mail bids or telephone bids, to determine the highest bid received, prior to open public auction. Open public auction then commences for a typically brief period, during which the very highest price is determined for the seller. Once the item has had a fair presentation to the live, real time participants and the participants have submitted or indicated their highest bid, and the auctioneer ends the bidding for the item.

It is the auctioneer who historically makes the definitive decision to end bidding for an item. This illustrates the necessity to allow wireless subscribers to participate in real time, as if they were physically present at the live auction. This invention allows wireless subscribers to participate in the auction, and interact with the auctioneer in the same manner as if they were physically present at the live auction.

Good faith dealing mandates that the highest bidder should secure the item in question, up to the closing of the auction for that item by the auctioneer. As such, the concept of bringing in wireless devices, to allow for a larger base of bidders, encourages greater participation, which leads to higher prices and better returns for the auction house.

FIGS. 1 and 2 depict the global elements of this system. As shown, the auctioneer selects an auction site to conduct the live auction, and the auction site can be a site that is remote from bidders. Attendees of the live auction include live bidders, wireless bidders, or a mix of each. A Local Auction Management Server (LAMS) is set up at the auction site, though can also be located remotely and accessed by a remote client, from the live auction site.

The LAMS server communicates in real time with a Proxy Server in communication with the wireless network. For simplicity, the proxy server is shown as a part of the wireless network. A live bidder, who has a wireless device in his/her possession, can arrange to be notified of the commencement of the auction, the impending auction of items they are interested in and can submit bids before the auction, during the auction and in some cases, after the auction has ended.

A time date stamp function is associated with all actions taken at the wireless device. This time date stamp can be derived by the device, or by the network receiving the command. In either case, the Wireless Network Proxy Server records and transmits the event to the LAMS server. The time date stamp allows bidders submitting bids through the wireless connection, to be treated fairly as to when bids are placed in order to determine who bid first and/or last. All elements of the system of the present invention are synchronized to a single clock source.

The live auction, conducted at the live auction site, will have attendees and an auctioneer, and assistants may also be present. As the auction is conducted, the LAMS server keeps track of the current bid and offer, for each and every item, through closing of the bids. As such, said information can be transmitted and shared through the LAMS server, through the remote Wireless Network Proxy Server(s), to the hand held devices interested in the particular auction. Additionally, a hand held wireless subscriber can indicate the items of interest and receive notification, only for those items. Notification means would remain restricted to the capabilities of the device. Audible, visual or tactile notification means can be utilized.

Communication from the bidder to the auction site is accomplished primarily by depression of a key, touching a screen, directing a pointing device or even through voice recognition. Stepping through the chain of events, an item comes up for bid in a given auction. Subsequent items yet to be bid upon, can be prearranged to notify the wireless bidders, in order to give them additional time to prepare to bid. Some users may be driving and will be urged by this system to safely park, prior to bidding. The LAMS server manages the auction and thus, receives information and current bid status from the auctioneer. This information can be shared in real time, with the wireless network, through the Wireless Network Proxy Server and its communications link to the LAMS server.

Communications to and from the wireless device(s), are mitigated by this server, passed to the auction site, verified and confirmed back to the wireless users. The system will be subject to the time delay from the LAMS server to the wireless device and from the wireless device to the LAMS server, if the buttons, touch screens point devices and the like, are used to indicate an action taken by the wireless device user. If the overall network can support real time events and insert negligible time delay, the system will be acceptable to users attending the event.

Alternatively, as another means to reduce any time delay, a voice communications path from the wireless device to the LAMS server or a centralized Auction Management Server can be automatically created, upon the user's indication that they will participate in the bid for that item. As such, the use of voice recognition cards, or touch tone detection can be incorporated, to allow the wireless device user to participate in a true real time auction event. This approach would remove negligible time delay from the subscriber's perceived and actual interaction with the event.

The auction site pipes any and all communications through a different audio connection, to the LAMS server, which in turn would be equipped with the audio communication circuit cards which are responsible for broadcasting the live event to any number of callers, gathering actions from callers and communicating the actions from the callers to the Auction Management System. Since the audio path from the auctioneer, to the LAMS server, is singular, the LAMS server can be located remotely. The advantage to this is to have a high density of audio communications lines from the wireless network to the LAMS server and share these lines between different, unrelated events or between simultaneous unrelated events.

In all cases, time/date synchronization of the entire network is proposed. The purpose of this element, is to allow bidders to know their actions are time date stamped in order to promote fairness. The environment of a live auction includes the knowledge that a bidder can get noticed in real time, and can encourage the bidder to participate because they can expect the right to be recognized as the last bidder to be promoted and supported. As a remote wireless bidder, this very same treatment is afforded by collecting all action from all wireless bidders electronically and indicating which wireless bidder is the current bidder. Simultaneous bids can be eliminated by looking at events in hundredth's of a second increments.

In the event of a genuine tie (two or more users depressing a button to place a bid at the same time at the same hundredth of a second) a random number generator could be consulted and one bidder is automatically picked. This entire sequence of events can be stored in the LAMS server and recalled at a later date. This element will also promote bidders participation and earnest.

Since the capabilities of wireless devices vary, what is intended is to match the auction event and each activity, to the wireless device' capabilities. In the case of a telephone, perhaps the buttons, display and audio path can be exploited. In the case of a Palm Top device, perhaps just the touch screen. As one skilled in the art can see, the interaction with the wireless user is limited to the capabilities of the device in question, but the ability to link the device to a real time auction event is what we claim, and so it is the novel and unique utilization of the capabilities of said device, which are bound to the auction event, in real time. The system, is based upon the wireless device, its supportive network, a series of servers, and either a local server at the event, or a remote server linked to the event.

Hence, the event is communicated to the wireless users and the wireless users can communicate their wishes, in real time. This system allows a wireless device to mimic the actual presence of said bidder, at the given live auction. In addition, as one skilled in the art can readily see, the users of such a system can expect features and functions currently not available through any other means. This can include but is not limited to early and automatic notification of an auction commencement, early and automatic notification of an item of interest, up for bid, ability to bid in real time, ability to verify the bid is received, in real time, ability to retract the bid, in real time, Time Date stamp of each tangible action of the wireless device user, and passage of any events to the auction, verification of receipt from the auction. Also included is the ability to pre-arrange an alternate wireless bidder, should the primary bidder be unavailable or out of range of their network, and the ability to perform all tasks through the wireless device or an Internet based GUI.

The system can utilize any suitable integration between the wireless device and the Internet GUI, where the device bids and the Internet GUI is providing identical information to Internet users. However, the Internet is not capable of true real time communication of the event.

Open architecture within each element, will allow for programmers to continue to enhance this system with more features. However, the basic elements remain the same. Although there are many networks, servers and links available in the open market, the novel and unique concept of allowing a wireless device user to attend a live auction is depicted in these drawings.

This wireless distributed certified real time bidding and tracking system for live events increases the number of participants, certifies and stores activities based on time and date, and synchronizes the activities and all elements of the system. The invention unbinds geographical restrictions and/or requirements or other impediments that are imposed to participate in a live event. The ubiquitous nature of wireless networks and devices is a powerful conduit for mining and development of the time and date stamp features described herein. The system can also record and store all user activities for data mining, target marketing or other promotional activities.

Another feature of the invention is that the wireless device can include voice recognition, so that the wireless participant bids using his/her voice. An integrated server is located at the wireless network or at the auction house. The wireless participant is notified by any suitable means, such as a phone call with automated voice, email, voice mail, message waiting indication, text mail, or display message. The wireless device includes a voice port, optionally with an activation button. The wireless bidder hears the auction and can bid by saying the word “bid.” The server indicates whether the bid was accepted, such as a high pitch bleep that indicates that you are the leader at your last bid, and a low pitch bleep to indicate your bid was too low. A key depression (touch tone) or a voice command indicates the current bid amount. The items of interest are updated online.

In accordance with an alternative embodiment of the invention, voice commands can be substituted for any and all keyboard actions, button depressions, touch screen depressions, point and click and the like. Voice commands are a superior means to allow the unteathered wireless device user to participate with greater ease, in an auction event.

Other features and functions can be made accessible to the user, aside from live auction functions such as, for example, a “One Voice” command. A participant is contacted via the wireless device with a spoken message from a server, recapping the day's successful and unsuccessful events. The user can say “WRAP” and the server would give a confirmation (such as a beep or a distinctive tone) which indicates that all purchased items are to be shipped to a pre-set shipping location and paid for with a pre-arranged means (Such as E-Bill-Pay, VISA, PayPal, etc. . . . ). The system recognizes multiple “WRAPS”: “WRAP” is the standard command, “WRAP ONE” means number ONE, etc.

Multiple wraps assist a sophisticated buyer who needs these features to move quickly through the auction process, more particularly, the post-auction process. (e.g., Wrap One is a command which allows the buyer to have more than one buying identity. To simplify the process of wrapping up the day's purchases, “Wrap One”, “Wrap Two”, “Wrap Three” and so on, solicits the beep tones from the server which indicates that the intended message was received for each command, and the commands issued were to ship all items under buying personality one and pay for them with the present preference for identity one. “Identity One” could be any associated handle, such as Probuyer22, whereas “Identity Two” could be yet another handle, such as YahooBuyer5 and the handles could be used superfluously at any Internet bidding site.

The user can record WRAPS as a macro, such as by an Internet interface or through an automated telephone, having predefined options. Alternatively, the WRAPS can be predefined macros that are stored. However, it is readily apparent that any suitable system or operation can be used to define WRAPS that a user can later implement by voice command.

A professional buyer may be concerned about inquisitive competitors tracking their own selected items, which EBAY allows, as an example. So a professional buyer would seek simplicity and having 9 id's could achieve this. “Wrap All” could solicit a ship and payment for any number of ids, perhaps 100 or more. This is all very important to use in illustrating the power of the “One Voice” concept described herein, as being a voice macro capability within the scope of this invention, for any and all suitable applications. For example, any single step or multitude of steps could be preset under a single spoken word, to invoke the macro. Multiple macros are possible and are claimed herein. Potentially, there could be an unlimited number of macros which falls to outer limits encountered with computing and computers (e.g., hard drive size, memory, etc).

Another feature of the invention is the use of an automated auctioneer. An automated auctioneer is provided for auctions which are electronic, such as E-Bay or YAHOO Auctions. The item being sold could be “commentated” upon by a live automated auctioneer that indicates, for instance, the highest bid, the user's present bid, and the asking bid. The actual voice could be a celebrity. Auction sites which are based on servers, such as the YAHOO and EBAY servers, have gender specific data and so, the automation effort could be deliberately hosted by a male, female, special, or other voicing, as is agreed upon by the seller and their auction management personnel and as is believed best suited for the item to be sold. “Roseanne” could host an auction of her own items for charity. Wireless attendees can be contacted by the automated auctioneer at a predetermined time prior to closing and the voice a male subscriber hears could be female, females hear a male, males hear male, females hear female or all parties could be set for a male auctioneer, female auctioneer. The auctioneer's voice could also be provided as live, not automated.

The means for creating an auctioneer voicing can be almost wholly automated, wherein the celebrity only needs to read a list of perhaps 200 words and phrases into the server and the server thereafter, can speed up, slow down, mix and permutate fill-in material to make the auctioneer's effort sincere and meaningful to buyers. Much like a radio broadcast, anything which comes up to be spoken to the participants, which the celebrity did not record, a suitable HOST VOICE could be used to fill in, from prerecorded words and phrases that are numbered in the tens of thousands. This permits the “screen” of an E-Bay Auction (for example) to be read mostly in “Roseanne's voice” with minimal effort on the celebrity's part.

The foregoing description and drawings should be considered as illustrative only of the principles of the invention. The invention may be configured is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. A system for providing real time tracking of live events occurring at a local site and live events of wireless participants, the system comprising:
a wireless device for each wireless participant, said wireless device recognizing voice commands and generating a live event for the wireless participant in response to a received voice command; and,
a local management server communicating with the wireless device in real time, the local management server receiving the local site live events and transmitting information regarding the local site live events to the wireless device and for receiving information regarding the wireless participant live events.

2. The system of claim 1, wherein the local management server is located at the local site.

3. The system of claim 1, wherein the local management server is located remote from the local site.

4. The system of claim 1, wherein the wireless participants are located at the local site.

5. The system of claim 1, wherein the wireless participants are located remote from the local site.

6. The system of claim 1, wherein the local site comprises a live auction.

7. The system of claim 1, wherein the time stamp further associates a time with the local site live events.

8. The system of claim 1, said local management server transmitting the received wireless participant live events to the local site.

9. The system of claim 1, wherein the local site live events comprise wireless participants live events.

10. The system of claim 1, wherein the wireless participant can cause a local site live event.

11. The system of claim 1, further comprising a wireless device having touch tone, digital key depression or voice command recognition, wherein the wireless participant can cause a local site live event through touch tone, digital key depression or voice command of said wireless device.

12. The system of claim 11, wherein the local management server receives wireless participant live events as touch tone, digital key depression or voice command.
